(19) United States
(12) Patent Application Publication
(10) Pub. No.: US 2004/0081175 A1
(43) Pub. Date: Apr. 29, 2004

(54) Network protocol for efficient distributed control

(76) Inventors: Richard W. Wall, Moscow, ID (US); Bradley A. King, Pocatello, ID (US)

Correspondence Address: Ormiston & McKinney, Suite 400, 802 W. Bannock, P.O. Box 298, Boise, ID, 83701-0298, US

(21) Appl. No.: 10/617,318

(22) Filed: Jul. 10, 2003

Related U.S. Application Data
(60) Provisional application No. 60/395,174, filed on Jul. 10, 2002.

(51) Int. Cl. H04L 12/56

(52) U.S. Cl. 370/397; 370/431

(57) ABSTRACT

Network protocol for efficient distributed control. A packet used to implement an embodiment of the invention includes a routing control list, routing control data, and a data field. The routing control list identifies a node responsible for passing the packet. The routing control data identifies a first communication media to be used to pass the packet to the identified node and a second communication media to be used to pass the packet from the identified node. The data field contains electronic data being transmitted by the packet.

### CROSS REFERENCE TO RELATED APPLICATION

This application claims subject matter disclosed in co-pending provisional patent application serial No. 60/395,174 filed Jul. 10, 2002, entitled Network Protocol For Efficient Distributed Control.

### FIELD OF THE INVENTION

The present invention generally relates to network communication, and, more specifically, to a network protocol with minimal overhead enabling it to be implemented on microcontrollers with low memory resources.

### BACKGROUND

Network communication protocols developed to support industrial and commercial data acquisition and control functions often do not meet the needs of production agriculture and similar industries, particularly in regards to spatial scale. In most industrial and commercial applications, the infrastructure to support data acquisition and control are included in the design of the facilities. In the case of production agriculture, the infrastructure is often lacking as the facilities were installed years earlier. Unfortunately, upgrading or remodeling are often cost prohibitive. Increasing knowledge of production agriculture processes along with the development of decision support models have increased the interest in providing closed-loop control capabilities to maximize production efficiency and minimize environmental impact from agriculture production practices.

The inability for production agriculture to pass on increased operational costs to purchasers of agricultural commodities makes it imperative that hardware needed to implement data acquisition and control functions be relatively inexpensive. Data acquisition and control systems available today through industrial or consumer-based suppliers either cannot be economically justified or are functionally inadequate to provide the required degree of control and instrumentation. Reducing installation and equipment costs lowers the cost of data acquisition and control systems. Using existing infrastructure for power and network communications works to minimize installation costs. Unfortunately, these infrastructures were originally installed without considering the need for network communication. While network communications can travel over existing communication media—power and telecommunication circuits for example—the existing communications media often does not provide the necessary connectivity for devices needing network communications. Consequently, communications using multiple and differing communication media is frequently needed. Differing communication media include physical circuits provided by power and telephone lines for example and wireless links provided by ultrasonic, radio or infrared signals.

Economical design for data acquisition and control systems requires efficient selection of microcontrollers. This is achieved by identifying the least expensive microcontroller that can accomplish a given task. A design that minimizes the burdens placed on a microcontroller allows the selection of lower priced microcontrollers. Consequently, an efficient communication protocol that lessens the burden on a microcontroller's capabilities is paramount to realizing benefits from a low-cost design.

As industries and businesses grow, even if the original facilities are designed with communications needs in mind, it is seldom the case that a single communications media is sufficient to provide the required connectivity in the future. This is even more the case for retrofitting existing facilities for automation using networked distributed control. Therefore, a memory efficient communication protocol is needed that requires minimal computing to implement. The protocol should accommodate existing infrastructures, allow for expansion and operate across multiple communication media.

### DESCRIPTION OF THE DRAWINGS

FIG. 1 is a schematic representation of center pivot irrigation system providing a network environment in which various embodiments of the present invention may be incorporated.

FIG. 2 is a block diagram of an exemplary network implemented for data acquisition as well as for controlling the irrigation system of FIG. 1.

FIG. 3 is a table illustrating the structure of a packet according to an embodiment of the present invention.

FIG. 4 is a table illustrating the structure of a routing control field according to an embodiment of the present invention.

FIGS. 5 is a table illustrating the structure and function of routing control data according to an embodiment of the present invention.

FIGS. 6 and 7 are block diagrams illustrating the creation of a routing control field for a response packet for single node communications according to an embodiment of the present invention.

FIGS. 8 and 9 are block diagrams illustrating the creation of a routing control field for a response packet for two node communications according to an embodiment of the present invention.

FIGS. 9 and 10 are block diagrams illustrating the creation of a routing control field for a response packet for three node communications according to an embodiment of the present invention.

FIGS. 11 and 12 are block diagrams illustrating the creation of a routing control field for a response packet for four node communications according to an embodiment of the present invention.

### DETAILED DESCRIPTION

INTRODUCTION: Data networking for distributed data collection and control in environments such as production agriculture requires a network with versatile capability to manage communications between mobile nodes and fixed nodes. The invented network protocol has been developed to meet distributed control needs in production agriculture. The invention may also support both peer-to-peer and master-slave networking management schemes. In one embodiment, five bytes of routing data and a list of addresses are required to make communications routing decisions and define where those decisions are to be made. This protocol is scalable by adding to the list of addresses and extending the number size of the routing data. The protocol works with other networking layers to deliver data packets across different communication media to extend the physical range often required for control networks in agriculture. Short explicit and automatic implicit messages minimize network traffic. The protocol has low network overhead and can be implemented on most microcontrollers even those with low memory resources.

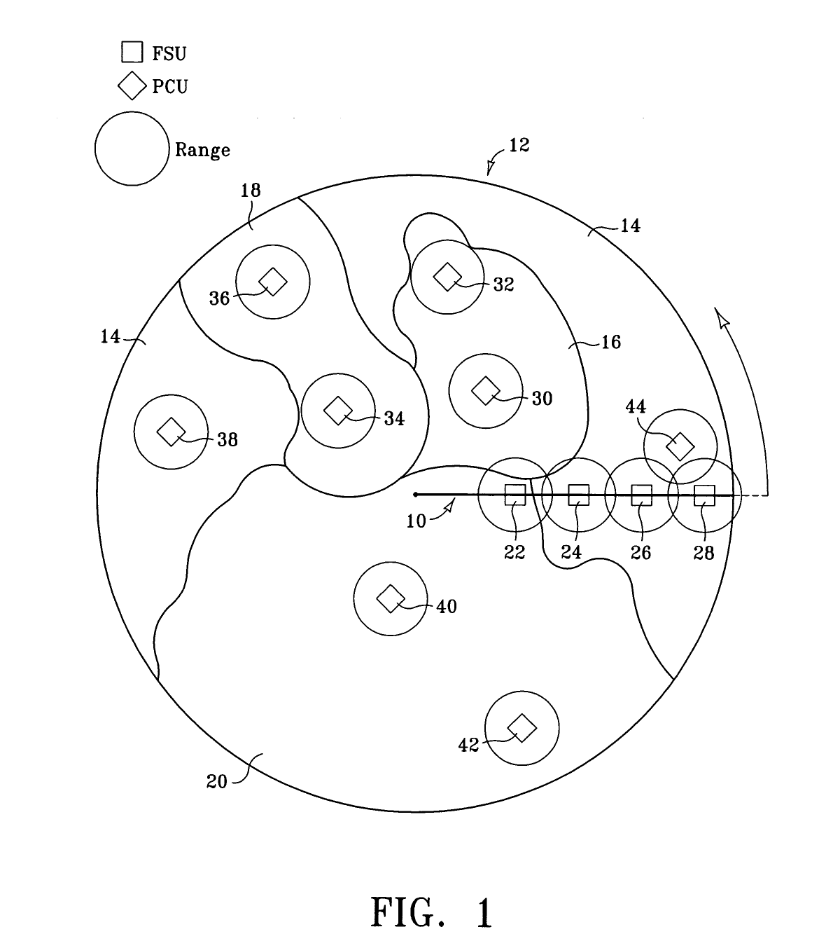

ENVIRONMENT: Center pivot and linear move irrigation systems provide an environment for distributed control networks that are not unlike many mobile systems such as those used for emergency operations or mining and construction operations. Part of the system can be geographically fixed while other parts have both temporal and spatial behavior. As FIG. 1 illustrates, center pivot irrigation system 10 represents a mobile platform that traverses field 12 rotating about pivot 11 while sampling data from management zones 14-20 located at key fixed locations. Center pivot irrigation system 10 is equipped with pivot control units (PCUs) 22-28 that are networked using the cable that powers the irrigation system's drive motors. Pivot control units 22-28 are nodes for providing data acquisition and controlling the amount of water applied. They also function as bridges for network communications to other nodes.

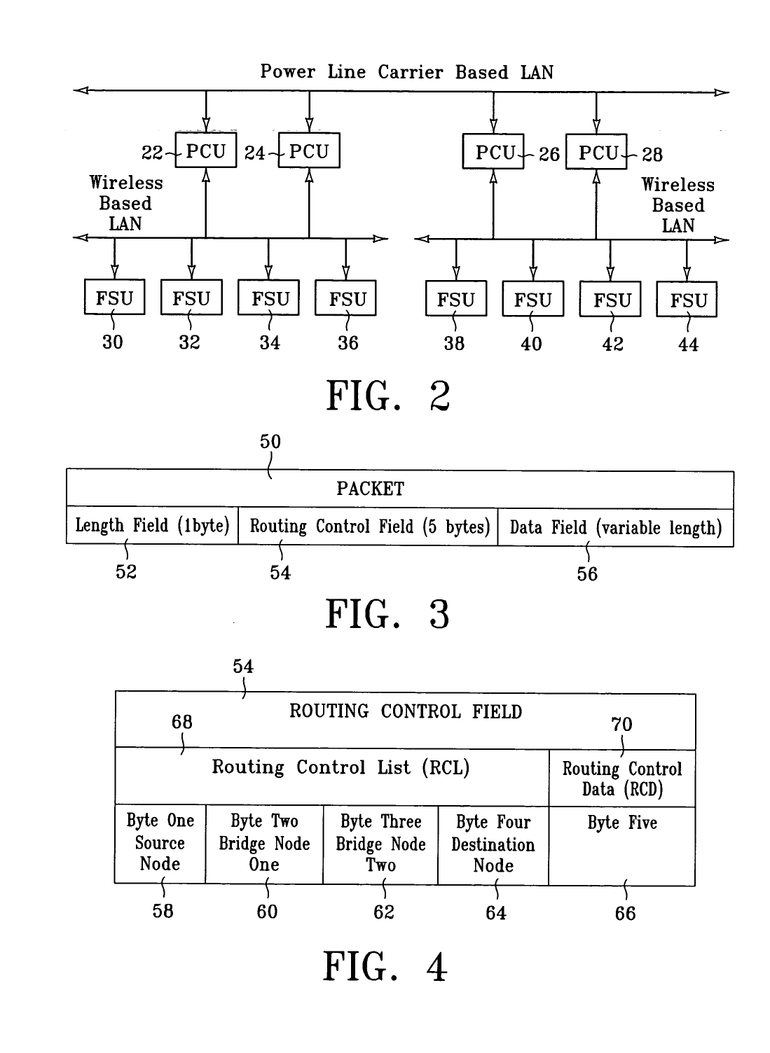

Field sensor units (FSUs) 30-44 are nodes equipped for wireless communication and are capable of acquiring data, facilitating control functions, and communicating data to PCUs 22-28. The wireless range of PCUs 22-28 and FSUs 30-44 limit the geographical range of the network communications resulting in temporal connectivity. For a given PCU, PCU 22 for example, to communicate directly with FSU 30, the circle around PCU 22 representing a communication range of PCU 22 must intersect with the circle indicating the range of FSU 30. FIG. 2 illustrates the network architecture implemented for data acquisition as well as for controlling the irrigation system of FIG. 1. It is expected that various embodiments of the present invention will enable the implementation of this network with high reliability and low capital investment. It is also important to note that while embodiments of the present invention may be described in relation to the efficient management of a center pivot irrigation system, the present invention can be implemented in any network environment. It is expected to be most useful in network systems where the network domain—that is, the infrastructure interconnecting the collection of devices that need to exchange information—is comprised of a number of sub-domains each able to directly interconnect only a limited number of those devices. Bridges interconnect one sub domain to another.

Obviously, control networks are not limited to central pivot irrigation systems. The description above illustrates only one of wide variety of such environments. A control network may, for example, be used to manage turf irrigation on a golf course or large commercial complex. A control network may be used to manage a dust suppression system in cattle feeding operation where large sprinklers spray water on each pen to reduce dust emissions. The control networks could be used to link dust control of individual pens spanning one hundred or more acres to meet the available water supply based on site-specific environmental conditions such as humidity, wind, surface moisture content, and temperature.

It is expected that embodiments of the invented network protocol will have application in any closed-loop control environment. However, the protocol's features excel in environments where the spatial scale of the control situation is large covering several acres or more and where some media for data communications already exist.

HARDWARE: When selecting a microprocessor for control units, the actual cost of the processor is only one factor that determines total system cost. Using development environments that require low initial investments and have minimal learning overhead minimizes engineering costs. The application of the processor requires that special attention be given to environmental constraints. Processor power is a concern for the FSUs 30-42 since they typically operate on battery and solar power. Studies show that simple and low-power processors are most reliable. Consequently, processor selection focuses on self-contained low cost microprocessors that operate on minimal power. Unfortunately, low cost is almost always part and parcel to low computational performance and/or low computing capability.

Processors have three basic resources that must be managed for most cost efficient utilization. Those resources are memory, input and output (I/O) pins, and processor time. To a large degree, excess capability of one resource can compensate for limitations in another. For example, using compiler optimizations that result in slower running programs can usually reduce memory requirements for program code. If a processor has sufficient speed for the application, then this is usually an acceptable compromise. The goal is to glean the most performance from the least expensive processor.

Microcontrollers are specialty self-contained microprocessors that are designed to meet requirements of embedded applications. Microcontrollers contain special function capability such as analog to digital converters, pulse width modulation, and multiple timers and counters. These specialty resources are also equipped with processor interrupt capability that facilitates real time control and multi-tasking.

As stated above, low cost often means low performance and for microcontrollers, the resource that is usually in highest demand is program and data memory. For example, the PIC16C77 processor (Microchip Technology, Inc., Chandler, Ariz.) often used for the FSU nodes has only 8192 words of program memory and 368 bytes of data memory, which is still small compared to programs that operate under Microsoft's Windows in today's PC environments that can require hundreds of megabytes of memory. With such constraints on memory, it is often paramount that the protocol used for managing the network communications be efficient for the microprocessor to implement.

PROTOCOL: The invented network protocol enables the management of information delivery across many tiers of networks. The protocol, requiring only five bytes of overhead for packet management, implements a peer-to-peer, dual communication media network communications with implicit and explicit packet acknowledgement. FIG. 3 illustrates the packet structure for the invented protocol. Packet 50 includes length field 52, routing control field 54, and data field 56. Length field 52 contains data, one byte in length, identifying the length of packet 50 measured in bytes. Based on its one byte or eight bit size, length field 52 can identify a length of up to two hundred fifty-six bytes. Routing control field 54 contains data, five bytes in length, identifying how packet 50 is to be routed. Data field 56 contains the data, also referred to as the payload, being routed. Due to the one byte size of length field 52 and the five bytes size of routing control field 54, the size of the data field is limited to two hundred fifty bytes, that is, two fifty six bytes less six bytes for length field 52 and routing control field 54. However, increasing the size of length field 52, can increase the maximum size for data field 56.

One notable characteristic of control networks is that the size of each packet 50 is extremely limited when compared to packets used for exchanging general information like electronic mail or web pages in larger networks. Unlike these larger networks, control networks have more strict delivery time requirements. When an instruction is directed to a component of a control network, those instructions must reach that component within amount of time without transmission errors. By comparison, it is nice but not essential that a “piece” of electronic mail reach its destination promptly. For non time-critical applications such as email, retransmission of data is, at most, inconvenient but more often inconsequential to both sender and receiver. Data retransmissions of control data can cause incorrect operations that either degrade system performance or constitute a system failure. Consequently, the shorter the network message, including overhead for packet delivery, the better a control network performs by reducing the occurrence of communications errors that require retransmission of data.

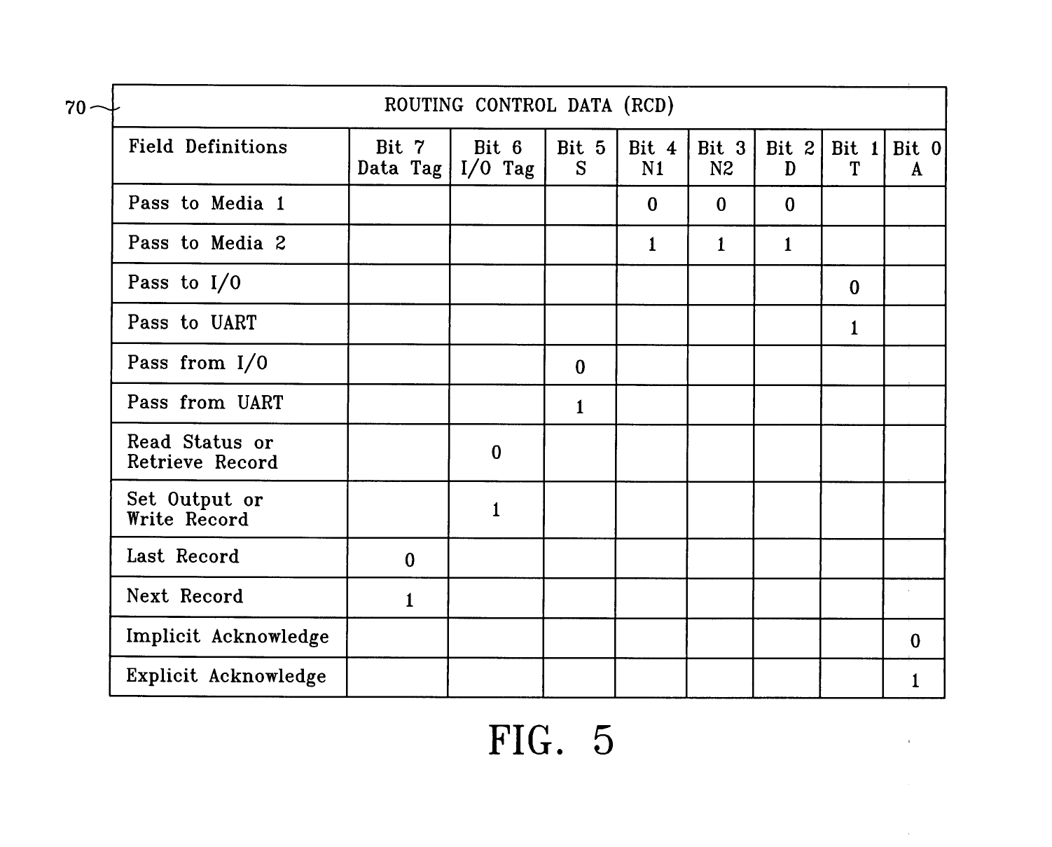

Referring now to the example of FIG. 4, routing control field 54 includes five bytes 58-66. The first four bytes 58-64 are referred to as the Routing Control List or RCL 68. The last byte 66 is referred to as the Routing Control data or RCD 70. The RCL 68 contains data identifying the nodes that are responsible for passing packet 50 to its destination. The RCD 70 contains data identifying the communication media that each node, identified in the RCL 68, must use to send packet 50 along to the next node in the RCL 68. Byte one 58 of the RCL 68 contains data identifying a source node. The source node is the node at which packet 50 originates. Byte four 64 contains data identifying a destination node. The destination node, as its name suggests, is the node to which packet 50 is directed. Bytes two and three 60 and 62 each contain data identifying a bridge node through which packet 50 must be negotiated to reach the destination node.

Based upon the size of the RCL 68, the invented protocol is capable of managing two hundred fifty-four nodes distributed across different communication media. All nodes have a unique identifier number between one and two hundred fifty-four. No node can have the address two hundred fifty-five as that address is reserved for routing as a skip node. For example, if byte two 60 and/or byte three 62 of the RCL 68 had a value of two hundred fifty-five, then packet 50 is not to be routed through nodes identified by those bytes. The address zero is reserved to be a general broadcast message. The broadcast message service can only be used if all nodes receiving the broadcast message will interpret data field 56 correctly. Except for broadcast messages, only the source node and the destination node need knowledge of how to interpret data field 56. All nodes must be able to interpret the routing control field 54.

FIG. 5 is a table illustrating the function of the RCD 70. Here RCD 70 is a byte. Bits two through five of the RCD 70 identify the communication media to be used to pass data to and from the source node (S), the destination node (D), and, potentially, two bridge nodes (N1 and N2). As determined by bit five of RCD 70, there are two possibilities for the data that is generated at the source node: either local input from digital and analog sensors (pass from I/O) or input from a device connected to a serial port (pass from UART). Likewise, there are two possibilities for data delivered to the destination node (determined by bit one), either the local analog and digital control outputs (pass to I/O) or a serial connection to an external device (pass to UART). The abbreviations I/O, short for Input/Output, and UART, short for Universal Asynchronous Receiver-Transmitter, represent examples of communication media for passing data to a source node and for passing data from a destination node. The concept being that once reaching the destination node, data can be directed to interfaces for local control and instrumentation or it can be directed to a communications link with an external computing device using a conventional RS232 protocol serial port. Similarly, a source node can receive data from interfaces for local control and instrumentation or it can receive data from a communications link with an external computing device using a conventional RS232 protocol serial port.

If the destination node receives a packet with the I/O tag—bit six—set low, then this node interprets the packet as an implicit request for data to be retrieved either from the local hardware I/O or from a device connected to the serial terminal as determined by bit one. In this case, the data field may be left blank or it may contain additional information to further qualify the data by the application code. If the data is being retrieved from a memory file, then bit seven determines if the next or the last data record is to be sent back to the source node. This allows for an efficient means to request data retransmissions in cases of undelivered packets.

If the destination node receives a packet where the I/O tag—bit six—is set high, then the destination node either passes the information from the data field to the serial device or distributes the data to various output devices based upon the needs of the application. After the destination node has successfully delivered the data to the serial device or implemented the output control, an explicit acknowledge packet is sent back to the source node that consists of the length byte and the five routing control field bytes with the acknowledge—bit zero—set high.

OPERATION: The invented protocol uses two types of routing—forward and back. Packet 50 is forward routed when it is sent independently, that is, not in response to another packet. Packet 50 is back routed when it is sent in response to a previous packet. A back routed packet is referred to as a response packet. The previous packet is referred to as an originating packet.

When forward routing, programming at the source node generates the RCL 68 and RCD 70 for packet 50. Only the source node must have knowledge of the network topology. Programming at the source node defines what bridging nodes will be used, if any, and the destination node. If the source node programming chooses to use a “send and wait” scheme, it must account for delivery and processing time at the destination. The transmission between bridges and the destination nodes are autonomous events. Only the source node programming has expectation of receiving a response packet in a certain period of time. To keep the processing overhead low at the bridging and destination nodes, packets are simply sent without checking on success with the receiving node.

The routing to the destination node (D) identified in byte four 64 and bridging nodes (N1 and N2), if any, identified in bytes 60 and 62 uses bits two through four of the RCD 70. When sending a packet, the source node looks at RCD 70 bit four and determines whether to send via communication media one or two. When receiving the packet 50, a bridging node first scans the RCL 68 for its own node address. If it is not found or if the message arrives via a communication media not specified by the RCD 70, the packet is not processed further by that particular node. This feature prevents the destination node from receiving multiple packets of the same data.

When a node identified in the RCL 68 receives packet 50, it searches bytes two, three, and four 60-64 of the RCL 68. If its address is found in byte two 60, which identifies bridge node one, then bit three of the RCD 70 determines the communication media to be used to pass the packet along to the next node in the RCL 68. Likewise, if the node finds its address in byte three 62, which identifies bridge node two, then bit two of the RCD 70 determines the communication media used to send the message along to the destination node which is identified by byte four 64. Bridging node address positions in the RCL 68 may not contain address zero but may contain the skip node address of two hundred fifty-five. Skip nodes are ignored and used as place holders in the RCL 68. For example, a packet 50 may not need to be routed through any bridge nodes, or it may only need to be routed through one bridge node. In theses cases the RCL 68 need not identify two bridge nodes, so one or both of bytes two and three 60 and 62 may contain the skip node address.

All packets invoke either explicit or implicit responses to inform the packet originator or source node that the packet was in fact delivered. Hence, the RCL 68 and RCD 70 of the packet must contain sufficient information for programming at the packet's destination node to return the appropriate response. Such a response, referred to as a response packet, is back routed to the source node of the originating packet. Programming at the source node for the back routed packet—that is the destination node of the originating packet—generates the RCL 68 and the RCD 70 for packet 50 by altering the RCL 68 and RCD 70 of the originating packet.

All packets can be classified into one of four possible categories depending upon the number of nodes involved in routing the packet. How the RCL 68 and RCD 70 of the originating packet are altered to generate the RCL 68 and RCD for the response packet depends upon which of the four categories the originating packet falls into. The category that the originating packet falls into is determined by the address of the destination node and by the number of skip nodes contained in the RCL 68 of the originating packet. Bits in the RCD 70 that control the communication media for skip nodes are ignored. Bridge nodes do not interpret the message data but simply rebroadcast the message without modification using the communication media specified by the RCD 70.

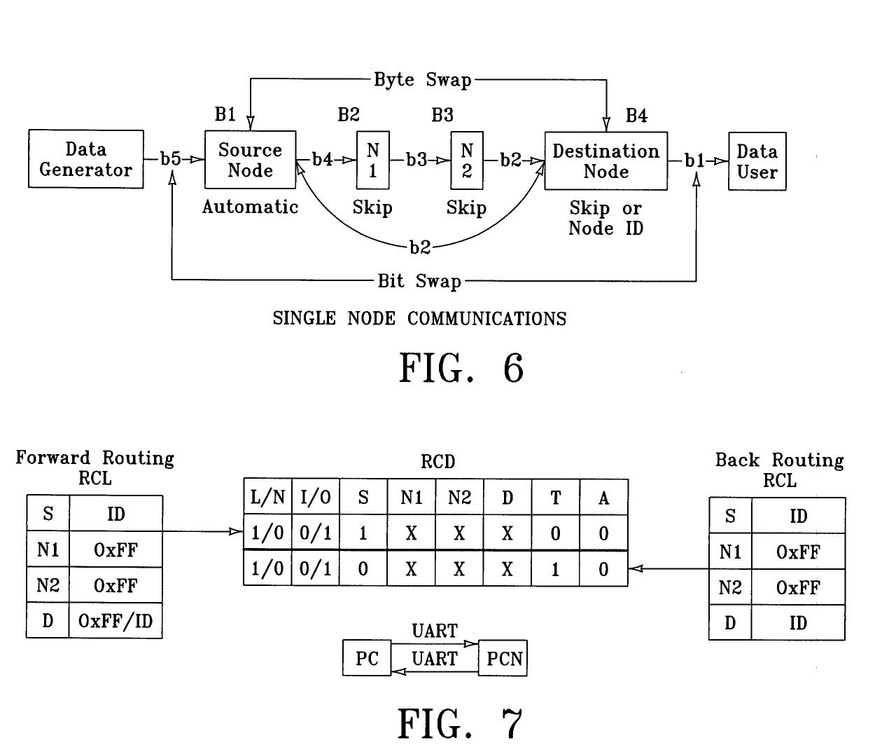

Category One: Single Node Packet—This category comes into play whenever an originating packet is routed through only one node. For the single node message, the destination node may be identified as a skip node or by the same address as the source node. Bridge nodes one and two are assigned skip node addresses. To generate the RCL 68 for a response packet, FIG. 6 shows that data in bytes one (B1) and four (B4) of the RCL 68 must swap locations. Bits one (b1) and five (b5) of the RCD 70 must be exchanged while bit 2 (b2) is left unchanged. FIG. 7 provides an example of a category one type originating packet and a resulting response packet. Entries containing “1/0” or “0/1” indicate that the particular bit may either be set high or low depending upon the particular application. An entry of “X” indicates that the status of the particular bit is irrelevant.

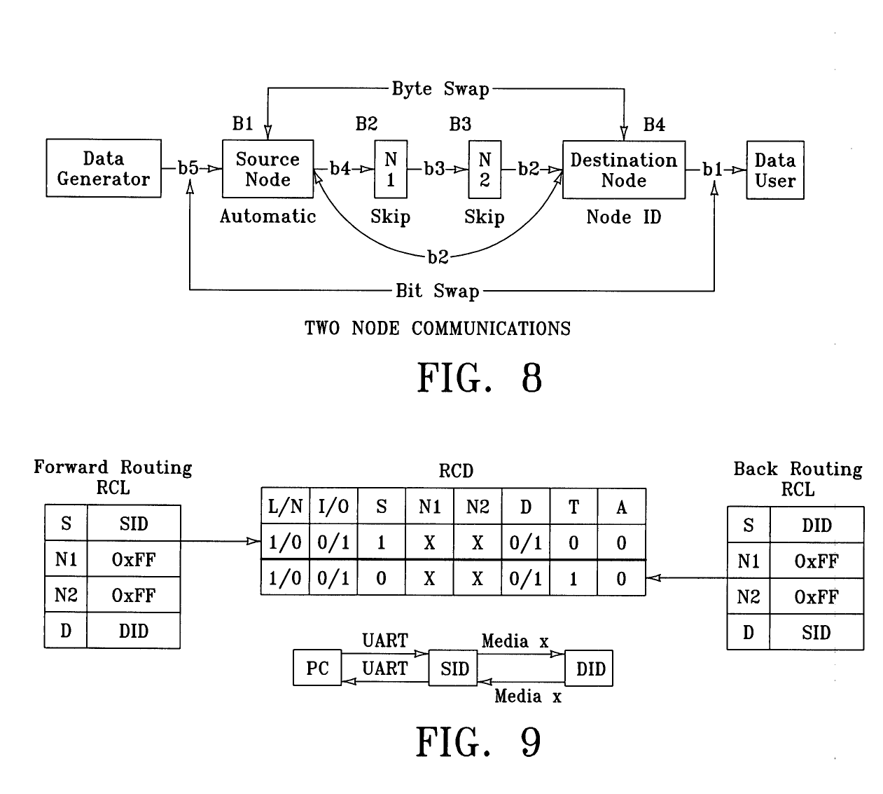

Category Two: Two-Node Packet—The two-node category arises where two active nodes are involved in routing an originating packet. The address of the destination node can be any value between one and two hundred fifty-four but not the address of the source node. The byte and bit swapping for this category are handled identically to the single node category. FIG. 8 illustrates the byte and bit swapping used to generate the RCL 68 for the response packet and FIG. 9 provides an example of a category two type originating packet and a resulting response packet. Entries containing “1/0” or “0/1” indicate that the particular bit may either be set high or low depending upon the particular application. An entry of “X” indicates that the status of the particular bit is irrelevant.

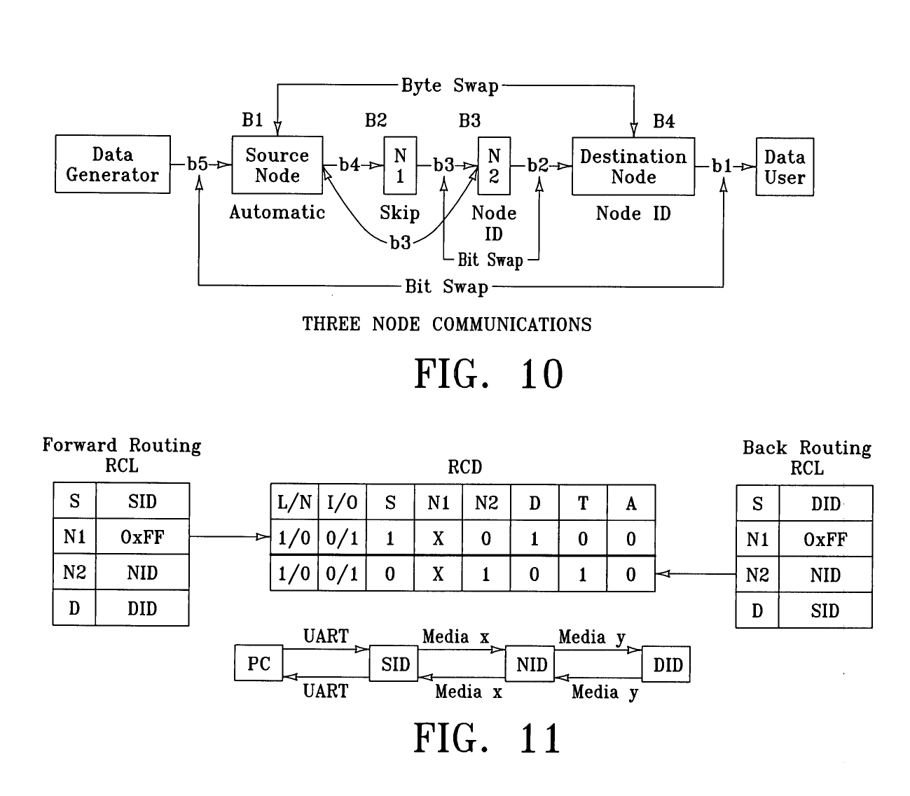

Category 3: Three-Node Packet—The three-node category arises whenever an originating packet is routed over two different communication media. The originating packet is routed from a source node to a bridging node on one communication media. The bridging node retransmits packet 50 in its entirety to the destination node. For this category, only byte three 62 (N2) is needed for a bridging node. Byte two 60 (N1) is set as a skip node. Bit four of the RCD 70 is ignored. FIG. 10 illustrates the byte and bit swapping used to generate the RCL 68 for the response packet. Like the single and two-node categories, bytes one (B1) and four (B4) of the RCL 68 are swapped as well as bits five (b5) and two (b2) of the RCD 70. The bridging node address stays in byte three 62 (B3) of the RCL 68, but the bits three (b3) and two (b2) of the RCD 70 are swapped. FIG. 11 illustrates an example of category three type originating packet and a resulting response packet. Entries containing “1/0” or “0/1” indicate that the particular bit may either be set high or low depending upon the particular application. An entry of “X” indicates that the status of the particular bit is irrelevant.

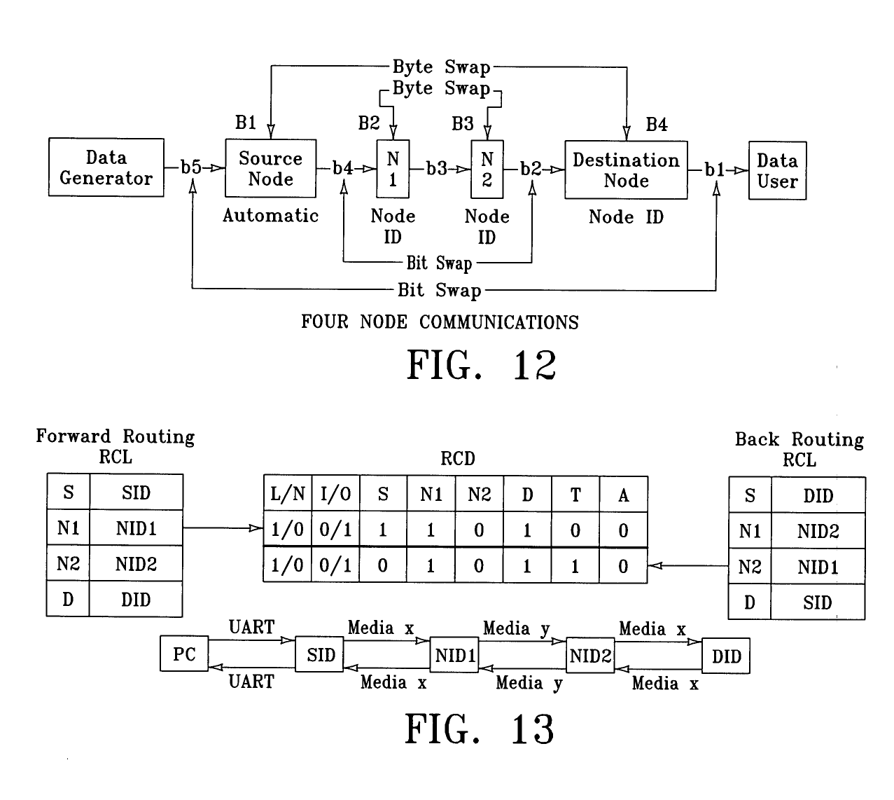

Category 4: Four-Node Packet—The four-node category arises whenever an originating packet is routed from one communication media to another and back again. This situation occurs where there is insufficient range in one or both communication media to deliver the originating packet. All four bytes in the RCL 68 are utilized, each containing the address of a different node. FIG. 12 illustrates the byte and bit swapping used to generate the RCL 68 for the response packet. In the RCL 68, bytes one (B1) and four (B4) are swapped as are bytes two (B2) and three (B3). In the RCD 70, bits one (b1) and five (b5) are swapped as are bits two (b2) and four (b4). In this category, bit three (b3) of the RCD 70 is the pivotal point. FIG. 13 shows an example of a category four type originating packet and a resulting response packet. Entries containing “1/0” or “0/1” indicate that the particular bit may either be set high or low depending upon the particular application. An entry of “X” indicates that the status of the particular bit is irrelevant.

SCALABILITY: As described in the examples above, the maximum size of a packet 50 is determined by the size of its length field 52. A one byte length field allows packet 70 to be up to two hundred fifty-six bytes in length. Increasing or decreasing the size of length field 52 similarly increases or decreases the maximum size of packet 70.

As described above, routing control filed 54 comprises a four byte routing control list 68 and a single routing control byte 70. The four bytes in routing control list 68 envision a network having fewer than two hundred fifty-five nodes and allow for up to four nodes to be involved in the delivery of packet 70 through a number of communication mediums. Increasing or decreasing the size of routing control list and/or routing control data similarly increases or decreases the number of nodes through which packet 70 can be delivered, the number of nodes the network can use, and/or the number of communication mediums through which packet 70 can be delivered.

CONCLUSION: It is expected that various embodiments of the present invention will fill the need for a communication protocol that is efficient, reliable, and versatile in terms of network configuration and communication media. The invented protocol's short explicit and automatic implicit messages minimize network traffic. The invented protocol can be implemented on microcontrollers with low memory resources and is independent of the communication media used. Back routing for response data packets can be accomplished by rule based bit and byte swapping.

The present invention has been shown and described with reference to the foregoing exemplary embodiments. It is to be understood, however, that other forms, details, and embodiments may be made without departing from the spirit and scope of the invention that is defined in the following claims.

What is claimed is:

1. A data transmission packet, comprising:
a routing control list identifying a node responsible for passing the packet;
routing control data identifying a first communication media to be used to pass the packet to the identified node and a second communication media to be used to pass the packet from the identified node; and
a data field containing electronic data being transmitted by the packet.

2. The packet of claim 1, wherein the routing control list identifies a plurality of nodes responsible for passing the packet, and wherein, for each identified node, the routing control data identifies a communication media to be used to pass the electronic data to that node and another communication media to be used to pass the electronic data from that node.

3. The packet of claim 2, wherein the routing control list also identifies a successive order in which the packet is to be passed from a first node to a second node and wherein the routing control data identifies that communication media to be used to pass the packet from the first node is the same communication media to be used to pass the packet to the second node.

4. The packet of claim 2, wherein the routing control list includes, for each of the plurality of nodes, a plurality of bits that identify that node.

5. The packet of claim 1, wherein the routing control data includes a first bit identifying the first communication media and a second bit identifying the second communication media.

6. The packet of claim 5, wherein the routing control data further includes a third bit used to request that data be returned to a source node and a fourth bit identifying the data to be returned.

7. The packet of claim 1, further comprising a length field identifying a length of the packet.

8. A computer readable medium having instructions for:
generating a routing control list identifying a node responsible for passing electronic data;
generating routing control data identifying a first communication media to be used to pass the electronic data to the identified node and a second communication media to be used to pass the electronic data from the identified node; and
assembling a packet containing the routing control list, the routing control data, and the electronic data.

9. The medium of claim 8, wherein the instructions for generating a routing control list include instructions for generating a routing control list identifying a plurality of nodes responsible for passing the packet, and wherein the instructions for generating routing control data include instructions for generating routing control data identifying, for each node identified by the routing control list, a communication media to be used to pass the electronic data to that node and another communication media to be used to pass the electronic data from that node.

10. The medium of claim 9, wherein the instructions for generating a routing control list include instruction for generating a routing control list that identifies a successive order in which the packet is to be passed from a first node to a second node and wherein the instructions for generating routing control data include instructions for generating routing control data identifying that the communication media to be used to pass the packet from the first node is the same communication media to be used to pass the packet to the second node.

11. The medium of claim 9, wherein the instructions for generating a routing control list includes generating a routing control list that includes, for each of the plurality of nodes, a plurality of bits that identify that node.

12. The medium of claim 8, wherein the instructions for generating the routing control data include instructions for generating routing control data that includes a first bit identifying the first communication media and a second bit identifying the second communication media.

13. The medium of claim 12, wherein the instructions for generating the routing control data include instructions for generating routing control data that includes a third bit used to request that data be returned and a fourth bit identifying the data to be returned.

14. The medium of claim 8, further comprising generating a length field, and wherein the instructions for assembling include instructions for assembling a packet containing the length field, the routing control list, the routing control data, and the data to be transmitted.

15. A computer readable medium having instructions for:
obtaining a first routing control list and a first routing control data from an originating packet, the routing control list identifying a node responsible for passing the originating packet, and the routing control data specifying a first communication media for passing the originating packet to the node and a second communication media used to pass the originating packed from the node;
generating a second routing control list identifying the node;
generating a second routing control data specifying the second communication media is to be used to pass a response packet to the node and that the first communication media is to be used to pass the response packet from the node; and
assembling the response packet from the second routing control list, the second routing control data, and data, if any, to be returned in response to the originating packet.

16. The medium of claim 15, wherein the first routing control data includes a first bit identifying the first communication media and a second bit identifying the second communication media, and wherein the instructions for generating a second routing control data include instructions for generating a second routing control data that includes:
a first bit equal to the second bit of the first routing control data; and
a second bit equal to the first bit of the first routing control data.

17. The medium of claim 15, having further instructions for generating a length field identifying a length of the response packet, and wherein the instructions for assembling include instructions for assembling the response packet from the length field, the second routing control list, the second routing control data, and data, if any, to be returned in response to the originating packet.

18. A computer readable medium having instructions for:
obtaining a first routing control list and a first routing control data from an originating packet, the routing control list identifying a plurality of nodes responsible for passing the originating packet, and the routing control data specifying, for each node identified by the routing control list, a communication media used to pass the originating packet to that node and another communication media used to pass the originating packed from that node;
generating a second routing control list by reversing the order in which the first routing control list identifies the plurality of nodes;
generating a second routing control data that, for each node identified by the second routing control list, specifies:
a communication media to be used to pass a response packet to that node that is the same communication media used to pass the originating packet from that same node; and
another communication media to be used to pass the response packet from that node that is the same communication media used to pass the originating packet to that same node; and
assembling the response packet from the second routing control list, the second routing control data, and data, if any, to be returned in response to the originating packet.

19. The medium of claim 18, wherein, for each node identified by the first routing control list, the routing control data includes a first bit identifying a first communication media used to pass the originating packet to that node and a second bit identifying a second communication media used to pass the originating packet from that node, and wherein the instructions for generating a second routing control data include instructions for generating a second routing control data that includes, for each node identified by the second routing control list:
a first bit equal to the second bit of the first routing control data that corresponds to the same node; and
a second bit equal to the first bit of the first routing control data that corresponds to the same node.

20. The medium of claim 18, having further instructions for generating a length field identifying a length of the response packet, and wherein the instructions for assembling include instructions for assembling the response packet from the length field, the second routing control list, the second routing control data, and data, if any, to be returned in response to the originating packet.
